(19) United States
(12) Patent Application Publication
(10) Pub. No.: US 2017/0190897 A1
(43) Pub. Date: Jul. 6, 2017

(54) THERMOPLASTIC ELASTOMER COMPOSITIONS ADHERING TO METAL SURFACES

(71) Applicant: Kraiburg TPE GmbH & Co. KG, Waldkraiburg (DE)

(72) Inventors: Florian Vetter, Kraiburg am Inn (DE); Ernst Lifka, Kraiburg am Inn (DE)

(73) Assignee: Krailburg TPE GmbH & Co. KG, Waldkraiburg (DE)

(21) Appl. No.: 15/312,392

(22) PCT Filed: May 18, 2015
(86) PCT No.: PCT/EP2015/060906

§ 371 Date: Feb. 17, 2017

(30) Foreign Application Priority Data
May 19, 2014 (DE) 10 2014 007 211.8

(51) Int. Cl. C08L 51/06; C08K 3/26; C08K 3/20; C08L 21/00; C08L 23/16

(52) U.S. Cl. CPC C08L 51/06; C08L 21/00; C08L 23/16; C08K 3/20; C08K 3/26

(57) ABSTRACT

Thermoplastic elastomer compositions which have excellent adhesion to metals and are extremely stable vis-à-vis the influence of acids and lyes. Further, a method for producing the thermoplastic elastomer compositions and a composite material as well as the use of the latter in various composite materials.

The present invention relates to thermoplastic elastomer compositions which have excellent adhesion to metals and are extremely stable vis-à-vis the influence of acids and lyes.

No particular pre-treatment of the metallic surfaces is required to achieve the adhesion. The use of adhesion promoters (so-called primers) or adhesives can be dispensed with. Constructive aids in the case of components such as for example bars, cavities, recesses and holes can also be dispensed with. The advantages of the materials according to the invention thus clearly increase the design and process freedom for design engineers.

The thermoplastic elastomer compositions according to the invention, also named TPE compounds hereafter, are characterized by a particular stability vis-à-vis the influence of acids and lyes at room temperature and also at increased temperatures. Important parameters such as swelling behaviour, hardness, elongation at break and tensile strength show only slight changes.

The TPE compounds have a Shore A hardness which is preferably, but not limited to, 30 to 90 ShA and consist at least of a mixture of a polar-functionalized TPE, of styrene-containing block copolymer (TPS) (A), an adhesion-supporting resin (B) and a process oil (C). Compounds according to the invention can optionally contain further constituents.

Thermoplastic elastomers (TPEs) combine the rubber-elastic properties of elastomers with the advantageous processing properties of thermoplastics. This combination of properties opens up to the TPE materials a plurality of applications such as for example in the interiors and exteriors of cars, for industrial devices, industrial tools, household devices, medical consumables and devices, hygiene articles such as toothbrushes, sports goods, bathroom fittings, toys, containers for food, to name only a few. The TPE materials acquire properties such as sealing and damping functions or are used for reasons relating to their pleasant feel and visual appearance.

In many of the above-named fields of application, there is the requirement to combine a thermoplastic elastomer with another class of material such as thermoplastic materials, ceramic materials, glass or metal, in a permanent, firmly bonded manner. At the same time, it is required that adhesives or primers be dispensed with, and also that the possible design freedom of the component to be produced be maximized. The aim is the combination of rigid elements with flexible elements in a single assembly or finished part. This is frequently accompanied by a cost reduction, for example through reducing production steps, reducing weight, shortening production times and/or low structural complexity of the individual and finished parts. TPEs have advantages as a flexible element in processing vis-à-vis vulcanized rubbers as, like thermoplastics, they can be processed simply, cost-effectively and by means of widely used technologies. A method as described in DE 19938015 makes an additional vulcanization step necessary, which prolongs cycle times. The vulcanization accordingly takes place after rubber or rubber-like plastic has been injected onto the metallic component. Only after completion of the vulcanization is removal from the mould possible.

A successful bond between TPEs and other materials is essentially dependent on the polarities of the TPE and the surface to be coated. Thus U.S. Pat. No. 8,071.220, DE 19645727, EP 2610305 and sections cited therein all describe that the polarity between TPE and substrate must be matched. For example, for good adhesion to polar surfaces, polar or polar-modified TPEs and/or TPE compounds should be used.

U.S. Pat. No. 8,071,220 teaches that typical TPVs consisting of non-polar, cross-linked elastomer particles dispersed in a continuous, thermoplastic phase (preferably non-polar polyolefins such as PP), show poor adhesion to polar substrates. As an improvement to the state of the art, the use of a TPV is proposed, which has improved adhesion to polyamide. The TPV consists of a polyolefin-based elastomer phase (preferably EPDM) and a thermoplastic phase which is at least 80% composed of one, or a mixture of several, functionalized polyolefins. Furthermore, elastomers in the form of unsaturated and/or hydrogenated, styrene-based triblock copolymers (TPS) can be used as elastomers or as admixtures to the polyolefin-based elastomers. Carboxylic acid, acid anhydride, acid chloride, isocyanate, oxazoline, amine, hydroxy and epoxy groups are named as functional groups. Acid anhydride groups are preferred; maleic acid anhydride (MAH) which is grafted at 0.5% to 2.0% onto polypropylene is particularly preferred. The functionalization of the elastomer phase is not claimed. Furthermore, the use of functionalized styrene block copolymers in the elastomer phase and the use of adhesion-supporting resins is not disclosed. Although named in the description, no examples with adhesion to metals or metallic surfaces are described. It has been shown that the disclosed TPVs show moderate to poor adhesion to metals and metallic surfaces. An admixture, described as advantageous, of polyamides to the functionalized thermoplastic phase of the TPVs rather causes the metal adhesion to deteriorate even further.

U.S. Pat. No. 8,193,273 also describes the adhesion of TPE compounds to polyamides (PAs). In this invention also, polyamide is mixed with a TPE compound. However, high-molecular-weight, maleinized polystyrene-poly(ethylene-butylene)-polystyrene block copolymer (MAH-g-SEBS) is used here. Furthermore, in the examples an MAH-grafted PP is used as a further adhesion component. Both U.S. Pat. No. 8,193,273 and the previously-named U.S. Pat. No. 8,071,220 are based on the idea that the admixed PA is to increase the actual adhesion to the PA substrate. However, as free PA can only be introduced into non-polar compounds moderately or not at all, it is attempted to bind the admixed PA using functional, reactive MAH groups covalently, either to the dispersed elastomers or, respectively, to the continuous thermoplastic phase or to the interfaces of the two phases. Experience has shown that in practice this approach shows only moderate success, as the admixed PA is probably present at the surface in too low a concentration to actively contribute to the adhesion. Rather, it is shown that dispensing with PA in the compound and thus the presence of free MAH groups makes possible a good adhesion to polar surfaces. Further constituents of the TPE compounds disclosed in U.S. Pat. No. 8,193,273 are plasticizers and resin (hydrocarbon resin) which is used as a process aid. Named resins are also used as tackifier resins in adhesives. An adhesion to metals is not disclosed in U.S. Pat. No. 8,193,273.

The patent EP 2610305 describes in detail the adhesion between TPE and polar surfaces of ceramics, metals or synthetic plastics. Furthermore, produced material composites are disclosed. A mixture of a TPE, a polyvinyl acetal and a polypropylene with polar groups is claimed. The TPE is based on block copolymers of vinyl aromatics (preferably styrene) and isoprene (SIS), butadiene (SBS), isoprene-butadiene mixtures (SIBS) as well as their hydrogenated variants (SEBS, SEEPS). Further constituents are process oils and tackifiers. Disadvantages of the described compounds are their limited processability and their stability vis-à-vis the influence of strong acids and lyes. Thus acceptable adhesion is achieved only in the compression moulding process but not in conventional injection moulding. Attempts to produce an adhesion between metal or glass and the TPE compounds in the injection moulding-insertion process fail. The sprayed-on TPE strips can easily be manually separated from the metallic or glass substrate. Limitation to a compression moulding process is disadvantageous for reasons of the clearly longer cycle times vis-à-vis injection moulding, in particular if high-volume series productions are sought. All the examples in EP 2610305 were prepared using the compression moulding process at 2 N/mm² for 3 minutes. A further disadvantage of the described compositions is their instability vis-à-vis strong acids and lyes. The compounds lose their adhesion and deteriorate in terms of their essential mechanical parameters such as tensile strength and elongation at break. This is mainly due to the chemical nature of the adhesive components used. Polyvinyl acetals are not hydrolytically stable vis-à-vis acids and release corresponding aldehydes. The vinyl acetal groups are converted to vinyl alcohol groups. The separation of aldehydes that are hazardous to health and strong-smelling (butyraldehyde in the preferred variant according to the invention) is undesired. As the polyvinyl acetals according to the invention are preferably only 55 to 88% acetalized, the remaining functional groups consist of either vinyl alcohol groups or vinyl acetate groups. Under the influence of lyes and acids, vinyl acetates separate off the acetate unit as acetate ion or as acetic acid; polyvinyl alcohol is formed. The high solubility of polyvinyl alcohols in aqueous media again contributes disadvantageously to the stability and adhesion of the described TPE compounds.

EP 2054227 describes a method for the production of a composite product from a thermoplastic (“hard plastic”, preferably ABS) and a TPS, based on styrene-based elastomer and polyolefin (“soft plastic”, preferably SEBS). It is further described that this composite product then withstands a galvanizing step. Claimed TPSs are particularly stable vis-à-vis chromo-sulphuric acid. Styrene-based elastomers or polyolefins functionalized with polar groups are not named. A reversal of the method does not succeed with claimed TPSs. It is shown that non-functionalized TPSs of EP 2054227 adhere poorly, or not at all, to metal or metallic surfaces (for example galvanized thermoplastics).

In order to allow a wide usability of TPE compounds for bonding with or adhesion to metals or metallic surfaces, in addition to the primary requirement for the adhesion, the stability vis-à-vis usual metalworking process chemicals is also to be borne in mind. Typical methods of metal surface (pre)treatment are de-greasing with organic solvents which may be soluble or insoluble in water, immersion, spraying or brushing using acids, lyes or their metal salt solutions. The use of acids or lyes is also called etching. Furthermore, electrochemical processes and galvanizing processes are usual. Abrasive methods such as grinding, brushing, blasting or polishing are also common. Regarding this, see also “A. V. Pocius, Adhesion and Adhesive Technology, Carl Hanser Verlag, 3rd Ed., Munich (2012), Chapter 7” and the literature cited therein.

Among the metal treatment methods, those for processing aluminium occupy a prominent position. The anodic oxidation of aluminium, types II and III, which are to be regarded as finishing methods, should be named in particular. These are described in “Die Praxis der anodischen Oxidation, W. Hübner, C.-Th. Speiser, 4th edition, Aluminium Verlag GmbH, DUsseldorf (1988)”.

Another method of treatment is “Nano Molding Technology” (NMT). This technology serves for the pre-treatment of a metal, especially aluminium, to increase adhesion vis-à-vis thermoplastics. NMT technology was published by the company Taisei plas Co. Ltd. in EP 1559542 and EP 1459882 or also at www.taiseiplas.com. In a multi-step method, aluminium or also other metals such as copper, magnesium, stainless steel, titanium, steel, galvanized steel, brass, are pre-treated (etched) so that the surface condition makes possible a direct adhesion of thermoplastic materials using injection moulding-insertion methods. Thus directly cast-on plastic elements such as for example snap closures, strengthening ribs and threaded bushes can be produced very simply. Furthermore, different further steps can then take place without the bonds produced becoming loosened. For example, the following are named as post-treatment: anodic oxidation, spin coating, sputtering, coating with enamel. The following are named as thermoplastic materials: PPS (polyphenylene sulphide), PBT (polybutylene terephthalate), PA types such as PA6 and PA66, PS (polystyrene) and PPA (polyphthalamide). The NMT was tested for usability in a master's thesis supported by Sony Ericsson Mobile Communications and Taisei plas Co. Ltd. (“Nanomolding Technology on Cosmetic Aluminium Parts in Mobile Phones—An Experimental Study, C.-O. Annerfors, S. Petersson, School of Mechanical Engineering, Lund University, (2007)”). Although the thermoplastic materials described, such as PPS or PPO, adhere well to metallic surfaces, they are not suitable for use as sealing or haptic elements because of their high level of hardness. In all the steps named with respect to the NMT, material bonds between metals and thermoplastics are named; adhesion between metals and thermoplastic elastomers and/or TPE compounds is not described. It has been shown that the TPE compounds described in the present invention manage with and even without the multi-step method of the pre-treatment of the metal of the NMT and at the same time achieve good adhesion results.

Because of the high level of stability of the TPEs according to the invention vis-à-vis acids and lyes, following the production of a bond of TPE and metal, other finishing steps such as for example an anodic oxidation can be applied without damaging the previously produced TPE-metal bond. This process freedom represents a substantial advantage vis-à-vis the state of the art.

The object of the invention was to provide TPE compounds which can form a permanent, firm material bond to metals and/or metallic surfaces, are stable against the influence of inorganic and/or organic acids and lyes and are simple to apply. TPE compounds according to the invention are to have a certain range of hardness and a corresponding elasticity. Furthermore, the compounds are to be processable, in particular in the injection moulding process, and require simple or no special pre-treatment of the metallic surfaces. In order to guarantee the highest possible degree of process freedom in typical chemical, non-abrasive metalworking treatment methods, after application the TPE compounds are to have a high level of stability vis-à-vis inorganic and/or organic acids and lyes. Both the adhesion to corresponding metallic substrates and important parameters such as swelling behaviour, hardness, elongation at break and tensile strength, are so far as possible to remain unchanged following the action of acids and/or lyes.

A particular object of the present invention was that the TPE compounds should have good adhesion to aluminium.

A further object was that the TPE compounds have good adhesion to aluminium and withstand the conditions of type II and type III anodic oxidation. In order to test the resistance of the TPE compounds to these processes, compounds to be tested were exposed to the following chemicals in succession on the basis of DIN ISO 1817:
85% phosphoric acid at 80° C. for 3 minutes
30% nitric acid at 23° C. for 3 minutes
70% sulphuric acid at 23° C. for 60 minutes
ammonium hydroxide pH 10 at 23° C. for 3 minutes

After each step the test pieces were thoroughly rinsed with distilled water. Following the action of all the chemicals the TPEs were examined with respect to their parameters. If there were shown to be slight changes in parameters in the case of hardness (±5 ShA), elongation at break (±20%), tensile strength (±30%) and swelling behaviour (±2%), the material was considered resistant. Resistance in the named test is hereafter to be equated with chemical resistance. In addition to chemical testing, the TPE compounds were examined with respect to their adhesion. In addition to the named parameter determinations, test pieces were assessed visually according to the grey scale (DIN EN 20105-A02/ISO 150-A02). Resistance is assumed if the test pieces are assessed as not worse than grey scale level 4/5.

The stated objects were achieved by a TPE compound comprising
(A) a polar-functionalized TPE containing a styrene-containing block copolymer (TPS) with a weight average molecular weight (M_{w}) of 50, 000 to 500, 000 g/mol, wherein the polar-functionalized TPE has polar groups which are selected from the group consisting of carboxylic acid, carboxylic acid anhydride, epoxy, hydroxy, amine or amide groups,
(B) an adhesion-supporting resin selected from aliphatic and aromatic synthetic resins or mixtures thereof and
(C) a process oil.

It is preferable if the TPE compound has a Shore A hardness of 30 to 90 ShA.

According to an embodiment of the TPE compound, it is preferable if the TPS is an A-B-A triblock copolymer.

It is further preferable if the A block of the triblock copolymer is polystyrene and the B block of the triblock copolymer is selected from polybutadiene, polyisoprene and/or polyisobutene.

Furthermore it is preferable if, in the TPE compound according to the invention, in the A block the styrene monomers can be partially or completely replaced with derivatives of styrene, preferably α-methylstyrene, 2-methylstyrene, 3-methylstyrene, 4-methylstyrene, 4-tert-butylstyrene, 4-cyclohexylstyrene or vinylnaphthalines, preferably 1-vinylnaphthaline and 2-vinylnaphthaline. In addition the B block can contain mixtures of dienes. Likewise, it is possible that the B blocks are partially or completely hydrogenated.

Compounds according to the invention can optionally contain further constituents. These include further TPEs, polar-functionalized TPEs, thermoplastics, polar-functionalized thermoplastics and additives. The polymer composition has a preferred Shore A hardness of 30 to 90 ShA.

The thermoplastic elastomers (TPEs) described herein are as defined in “G. Holden, H. R. Kricheldorf, R. P. Quirk (Eds.), Thermoplastic Elastomers, Carl Hanser Verlag, 3rd Ed., Munich (2004)”, in DIN EN ISO 18064 or at “http://en.wikipedia.org/wiki/Thermoplastic_elastomer”. A distinction is made between the following thermoplastic elastomers based on styrene block copolymers (TPSs), polyesters (TPCs), polyurethanes (TPUs), polyamides (TPAs), polyolefins (TPOs) and cross-linked TPE (TPVs) based on cross-linked elastomer particles which are present dispersed in continuous thermoplastic phases.

The TPE compounds according to the invention consist of at least a mixture of a polar-functionalized TPS (A), an adhesion-supporting resin (B) and a process oil (C) and are to be stable vis-à-vis the influence of inorganic and/or organic acids and lyes. It has further been shown that the substance classes TPU, TPC and TPA are not very, or not, suitable for this.

If the adhesion to metals of non-functionalized TPSs which are rather non-polar, and the polar TPUs, TPAs and TPCs is compared, it is shown that the polar TPEs yield better values. The disadvantage of these substance classes is however that, under the action of acids and/or lyes, they partially, or sometimes even completely, decompose. This is a hindrance to achieving the required object of chemical resistance.

On the other hand the TPS substance classes show good resistance vis-à-vis inorganic and/or organic acids and lyes. In order to allow an adhesion to metals however, TPSs according to the invention must be polar-functionalized. Although EP 2054227 teaches the good resistance of TPS vis-à-vis acid, named TPSs cannot be used for permanent, firmly bonded adhesion to metals, due to the lack of polar groups. Polar-functionalized TPSs (A) show both good adhesion and good chemical resistance.

TPSs according to the invention are A-B-A triblock copolymers wherein the A block is usually polystyrene and the B block is usually made up of polybutadiene, polyisoprene or polyisobutene (SBS, SIS, SiBS). Alternatively, in the A block the styrene monomers can be partially or completely replaced with derivatives of styrene, such as for example a-methylstyrene, 2-methylstyrene, 3-methylstyrene, 4-methylstyrene, 4-tert-butylstyrene, 4-cyclohexylstyrene or vinylnaphthalines such as 1-vinylnaphthaline and 2-vinylnaphthaline. The B block can also alternatively contain mixtures of dienes such as SIBS (B block of a mixture of butadiene and isoprene). Furthermore, TPSs consisting of styrene and diene monomers can also be used as hydrogenated derivatives. The B block units are present partially or completely hydrogenated.

Polystyrene-block-poly(ethylene-co-butylene)-block-polystyrene (SEBS) and polystyrene-block-poly(ethylene co-(ethylene-propylene))-block-polystyrene (SEEPS) may preferably be named here. In addition to triblock, di-, tetra- or multi-block copolymers of named monomers of styrene, styrene derivatives (A blocks) and butadiene, isoprene, isobutylene and mixtures thereof (B blocks) in different sequencing of A and B blocks (for example B-A-B, A-B-A-B, etc.) can also be used as an alternative. Preferred TPSs are constructed of A-B-A triblock copolymers.

TPEs according to the invention based on TPS have a weight average molecular weight (M_{w}) of from 50,000 to 500,000 g/mol, preferably from 100,000 to 400,000 g/mol.

Not to be confused therewith are block copolymers based on styrene, which are used for contact adhesives (PSA, pressure sensitive adhesives). Although their molecular structure is very similar, the latter have a rheological behaviour different to that of TPE. Contact adhesives must already establish adhesion to the substrate with light pressure (finger pressure) and at room temperature. In order to achieve this, block copolymers clearly below Mw 50,000 g/mol are used. TPE compounds according to the invention show no adhesion under these conditions and cannot form films. Furthermore, they differ substantially from hot melts, a further important class of adhesives. Hot melts must flow under the action of temperature (usually >100° C.) and form films without further intervention. Generally, TPEs and TPE compounds must both be heated and also sheared in order to be able to be processed. Merely heating usually results in a decomposition of the material without any noticeable melting or flowing. Furthermore, adhesives are formulated so that they can be applied as thin layers. There is no requirement for a three-dimensional, shaping extension or structure. TPEs and TPE compounds as a rule have a structural extension in three dimensions. TPE compounds according to the invention also have adhesive properties in addition to the structural extension. However, to describe them as adhesives is misleading.

Surprisingly, it has been shown that the combination of a polar-functionalized TPS (A), an adhesion-supporting resin (B) and a process oil (C) is enough to achieve the stated object of the present invention, namely metal adhesion accompanied by chemical resistance and simple processing.

To achieve the adhesion, it is necessary to polar-functionalize TPS according to the invention. Polar modification can take place by grafting. Polar groups can be: carboxylic acid, carboxylic acid anhydride, epoxy, hydroxy, amine or amide. A person skilled in the art is familiar with radical grafting methods for introducing these polar groups. Using, for example, peroxide initiators, (meth)acrylic acid, MAH, glycidyl (meth-)acrylate or acrylamide are reacted with corresponding TPSs according to the invention. The grafting can take place in a separate step or during the production of the compounds according to the invention. A grafting preferably takes place before the compounding process. Preferred grafting levels lie between 0.5 and 5.0%, particularly preferably between 0.5 and 3.0% and quite particularly preferably between 1.0 and 2.5%. MAH is to be named as preferred grafting reagent, particularly preferably in the range from 0.5 to 3.0%. A TPS grafted with 1.0 to 2.5% MAH is quite particularly suitable as component (A) used according to the invention. The determination of the grafting level can be carried out with all the analytical methods known to a person skilled in the art, both with wet chemicals via titration of, for example, acid groups and by instrumental analysis (GC-MS, NMR, IR, UV-Vis, elemental analysis etc.). These methods are known to a person skilled in the art.

In U.S. Pat. No. 8,193,273, different commercially available MAH-grafted TPSs are named, such as Kraton MD 66840S, Kraton MD 6933, Septon 4077 or Septon 4099. As a further MAH-grafted TPS, Kraton FG 1901GT, for example, is commercially available.

It has proved advantageous to take care during the functionalization with reagents named by way of example, that during the grafting up to the application of the finished TPE compound to a metallic surface, the polar groups do not react with either further additives or impurities, and thus no longer contribute to adhesion at all, or only moderately. Thus, for example, a TPE functionalized with acrylic acid or MAH groups should not react with free amino or amide functions of a polyamide or free hydroxy groups of a polyester. Also disadvantageous is the use of natural resins (collophonium), as some of these also have free hydroxy groups. Further disadvantageous is the use of alkyl silicate resins that are sensitive to hydrolysis. These separate off alcohols which in turn can react with, for example, MAH-functionalized TPEs.

Furthermore, it has proved advantageous to bind the polar, functional groups to the polymer chains of the TPSs according to the invention, so that they are stable vis-à-vis the influence of acids or lyes, which means that they are not separated off. Carbon-carbon linkages between polar groups and TPSs are therefore preferred.

The component (B) of the present invention is an adhesion-supporting resin. This is also widely referred to as tackifier and is found in a very wide variety of applications of adhesives or lacquers. In Chapter 10.2.2 of “A. V. Pocius, Adhesion and Adhesive Technology, Carl Hanser Verlag, 3rd Ed., Munich (2012)”, and also in EP 2610305 and DE 102004063516 a very wide variety of tackifiers are described. From the plurality of resins listed, those which are chemically resistant within the meaning of the invention are particularly suitable for the present invention. Resins with carboxylic acid ester bonds, such as colophonium resins (rosin) and hydrogenated variants thereof are less suitable. Hydrolysable alkyl silicon resins of DE 102004063516 are to be avoided, as cleavage products react with the polar units of the component (A) according to the invention. Rather, synthetic resins based on cracker products are suitable and preferred. A distinction is made here between aromatic and aliphatic tackifiers. The adhesion-supporting resin is thus preferably selected from aliphatic and aromatic synthetic resins or mixtures thereof.

The aliphatics are mostly based on C5 cuts of cracker fractions. V. Pocius describes further classes of tackifier which can be used in principle. Synthetic resins or mixtures of synthetic resins have proved to be preferred adhesion-supporting resins (B). Aromatic, C₅-based aliphatic resins or mixtures of aromatic and C₅-based resins which are preferably hydrolysis-stable vis-à-vis acids and lyes are particularly preferred. Suitable commercially available resins are, for example from the group of aromatic resins, the Endex types from Eastman such as Endex 155® or Norsolene® W140 from Cray Valley, and from the group of aliphatic resins, Eastotac types such as Eastotac H-130R®.

All the process oils usual for the production of TPE compounds, also named plasticizers, can be used as process oils (C) according to the invention. These include paraffinic, naphthenic or aromatic oils. White oils, both technical and medicinal, are included among the paraffinic oils and may also be named. Furthermore, the process oils (C) according to the invention also include synthetic oils such as GTL oils or hydrogenated oils. Hydrolytically labile oils or plasticizers with ester bonds such as those based on phthalic acid esters (for example dioctyl or dibutyl phthalate), native oils (for example rapeseed or soya oil), alkyl sulphonates or generally mono-, di- or higher alkyl acid esters are not very, or not at all suitable.

In addition to improving the processability, the oils essentially have the function of adjusting the final hardness of the compounds according to the invention.

TPE compounds according to the invention comprising or consisting of at least a mixture of a polar-functionalized TPS (A), an adhesion-supporting resin (B) and a process oil (C) can optionally contain further constituents. These include further TPEs, polar-functionalized TPEs, thermoplastics, polar-functionalized thermoplastics and additives.

Further TPEs are selected from the group of TPSs, TPOs and TPVs for reasons of chemical resistance. Preferably TPSs and TPOs. The optional TPE selected from the same TPE class as component (A) is quite particularly preferred.

Different types of TPO can be used as TPO (A). Both those which consist of polyolefin-based block copolymers and also mixtures of thermoplastic polyolefins and elastomeric rubbers. Block copolymers of olefins such as propylene and ethylene (for example PP-PE-PP or block-PP-block-(co-PE-PP)-block-PP) or hydrogenated block copolymers of butadiene and isoprene (B-I-B) are to be named by way of example. Examples of mixtures of thermoplastic polyolefins and elastomeric rubbers include those of isotactic PP and EPDM rubber. TPOs according to the invention are described in detail in Chapter 5 of “G. Holden, H. R. Kricheldorf, R. P. Quirk (Eds.), Thermoplastic Elastomers, Carl Hanser Verlag, 3rd Ed., Munich (2004)”. Further types of TPO are named on page 93, in addition to those already listed. It is to be noted that the definition of a TPO of ISO EN 18064 differs from that of G. Holden. TPO according to the DIN standard consists exclusively “of a mixture of a polyolefin with a usual rubber, wherein the rubber phase in the mixture has slight or no cross-linking”. TPVs differ from TPOs in that the elastomeric phase is additionally, usually dynamically, cross-linked. TPOs composed of block copolymers of PP and PE and mixtures of PP and EPDM are preferred according to the invention. PP and EPDM are quite particularly preferred TPOs for the production of polar-modified TPO (A).

Further polar-functionalized TPEs can be modified TPSs or TPOs, as already described as component (A), wherein either the polar group, the content of the polar group or the TPE class is other than that of component (A).

Optional thermoplastics of the TPE compounds according to the invention are those which are compatible with TPSs, TPOs and polar-functionalized TPSs and TPOs (A) according to the invention and are hydrolytically resistant vis-à-vis lyes and acids. PE, PP, polystyrene and PVC are to be named here by way of example. HDPE, LDPE and PP are preferred.

Furthermore, polar-functionalized thermoplastics can be admixed with the compounds according to the invention. The possible polar groups are selected from carboxylic acid, carboxylic acid anhydride, epoxy, hydroxy, amine or amide groups. As with the TPEs, the polar groups can be introduced by means of grafting. The methods are known to a person skilled in the art. Radical grafting using peroxide initiators is to be particularly highlighted. A grafting preferably takes place before the compounding process. Preferred grafting levels lie between 0.5 and 5.0%, particularly preferably between 0.5 and 2.0%. MAH is to be named as preferred grafting reagent, and PE and PP as preferred thermoplastics to be grafted. A detailed description of the grafting of PP is to be found for example in EP 2610305, to which reference is made here. Commercially available products are for example the Scona® types from Byk such as Scona® TSPE, MAH-grafted PE or Scona® TPPP MAH-grafted PP.

Furthermore, compounds according to the invention can contain further additives. Process adjuvants, stabilizers or fillers are to be named.

The following are to be named as process adjuvants and stabilizers: antistatics, antifoaming agents, lubricants, dispersants, separating agents, anti-blocking agents, radical scavengers, antioxidants, biocides, fungicides, UV stabilizers, other light stabilizers, metal deactivators, furthermore also additives such as foaming adjuvants, expanding agents, flame retardants, flue gas suppressors, impact resistance modifiers, adhesives, anti-fogging adjuvants, dyes, colour pigments, colour master batches and viscosity modifiers. The following are for example mentioned as fillers: kaolin, mica, muscovite, phlogopite, calcium sulphate, calcium carbonate, silicate, silica, talc, carbon black, graphite or synthetic fibres.

The hardness of the TPE compounds according to the invention lies in the range from 30 to 90 ShA, preferably 40 to 80 ShA, quite. particularly preferably from 50 to 70 ShA.

The TPE compounds according to the invention comprise or consist of at least a mixture of a polar-functionalized TPS (A), an adhesion-supporting resin (B) and a process oil (C). The components (A) and (B) of the TPE compounds are used in an (A):(B) weight ratio of from 10:1 to 1.5:1, preferably 5:1 to 2:1 and quite particularly preferably of from 4:1 to 2.5:1.

The process oil (C) is admixed depending on the required hardness and depending on which components (A), (B) and optional, further constituents are admixed with compounds according to the invention. As a guideline it can be said that the softer the TPE compound the more (C) will be contained. Typically (C) is added in the range of from 50-5 wt. %, preferably from 40 to 10 wt. % and particularly preferably from 40 to 15 wt. %, relative to the final TPE compound.

Furthermore, TPE compounds according to the invention in addition to (A), (B) and (C) can contain further constituents such as TPEs, polar-functionalized TPEs, thermoplastics, polar-functionalized thermoplastics and additives.

It is shown that the total weight of (A), of all further TPEs and polar-functionalized TPEs is to be selected in a weight ratio to the component (B) of from 10:1 to 1.5:1 and preferably from 5:1 to 2:1.

The added quantities of optional thermoplastics and polar-functionalized thermoplastics total from 0 to 30 wt. %, preferably 0 to 20 wt. % and particularly preferably 0 to 10 wt. % relative to the total weight of the TPE compounds.

From the list of possible additives, fillers from 0 to 30 wt. %, preferably 0 to 20 wt. % and in particular 0 to 15 wt. % are added. UV-stabilizers, process stabilizers and antioxidants contained in the TPE compound are in the range of from 0 to 2 wt. %, preferably 0 to 1 wt. %. The percentages by weight of the optional additives relate to the respective total weight of the TPE compounds according to the invention.

TPE compounds of the invention show excellent, permanently firmly bonded adhesion to metals and metallic surfaces. No complex pre-treatment is necessary to achieve the adhesion. Likewise the use of primers or adhesives can be dispensed with. Additional constructive aids for the components to be manufactured which have to compensate for poor adhesion (bars, cavities, etc.), are not required. TPE compounds according to the invention make possible substantial advantages with respect to design and process freedom. The TPE compounds, as well as components produced from them, thus represent a clear advantage vis-à-vis the state of the art.

By less complex pre-treatment of the metals and metallic surfaces is meant, for example, that only the surfaces are degreased with common organic solvents or solvent mixtures which are water-soluble or insoluble (for example: acetone, isopropanol, ethanol, toluene, xylene). Furthermore, by less complexity is meant that the surfaces are slightly roughened using grinding, brushing or blasting. This has, among other things, the advantage, that oxide layers on the surface are partially or completely removed. Of course general or special methods of metal surface pre-treatment, such as for example the NMT method of EP 1559542, can also be used, before TPE compounds according to the invention are applied in firmly bonded manner. Thus the TPE compounds can very simply be incorporated into existing processes. In particular in the cases where TPE is not sprayed over the complete surface of a component and previous or subsequent process steps make a surface pre-treatment necessary. Thus composite materials of a very wide variety of classes of material can be produced, for example a consumer electronics component made of metal (for example a mobile phone), pre-treated by means of NMT, which in addition to TPE as sealing material also additionally contains thermoplastic elements for the threaded bushes.

TPE compounds according to the invention can be processed cost-effectively and by means of widely used technologies, in order to produce material bonds to metals and metallic surfaces. Both non-noble metals and noble metals are to be understood as metals. Alloys of metals are included. Aluminium, copper, magnesium, titanium, steel, stainless steels (for example V2A, V4A), zinc-plated steels, galvanized steels with coatings of copper, nickel, chromium or other metals may be named by way of example. Furthermore, plastics and plastic components which have coatings of metal or are metallized using galvanic processes, may be named. These are coated with metallic surfaces within the meaning of the invention. Material bonds of the TPEs according to the invention to metals, particularly preferably to aluminium, copper, titanium and stainless steels, are preferred.

Although not listed in more detail, some of the compounds according to the invention also have very good adhesion to other surfaces such as glass, ceramics and technical plastics, especially thermoplastics.

After application and production of the bond with a metal or a metallic surface, TPE compounds of the present invention have a high level of stability vis-à-vis inorganic and/or organic acids and lyes and, following contact with acids and/or lyes, continue to have very good adhesion to corresponding metallic substrates and show no, or only slight, changes in important parameters such as swelling behaviour, hardness, elongation at break and tensile strength. This chemical resistance is advantageous when post-treatments take place after production of the bond between TPE compound and metallic substrate. Chemical post-treatments and/or post-treatments using chemicals are to be named in particular. These also include, for example, anodic oxidation of aluminium. Post-treatments frequently serve for the further finishing of the metallic surface for the purposes of corrosion protection or a special surface condition and or visual appearance. Of course a resistance of finished parts vis-à-vis acids and lyes is an essential advantage in many applications. For example control elements made of TPE (buttons) which come into contact with perspiration.

A subject of the invention is thus also a method for producing TPE compounds as described above using an extruder, internal mixer or kneader, preferably an extruder or a twin screw extruder.

A further subject of the invention is also a method for producing a composite material, wherein the composite material is produced by means of injection moulding, injection moulding-insertion methods, extrusion, compression moulding methods, preferably using injection moulding, injection moulding-insertion methods and extrusion, quite particularly preferably by means of injection moulding-insertion methods using a TPE compound as described above and a further substance, selected from metals, glass, ceramic, thermoplastics and mixtures thereof.

The production of the TPE compounds is carried out using conventional mixing units. Suitable units can be extruders, internal mixers or kneaders. The homogeneous distribution of the individual raw materials of the respective compound is to be ensured. Extruders, in particular twin screw extruders, are preferred units.

The TPE compounds of the invention are characterized by excellent flow and processing properties. The TPE can be applied to the metallic substrates in a very wide variety of forms in order to provide the composite product.

Common processing methods for TPEs and thermoplastics can be used for producing the bond between rigid elements (metallic or metallized component) and flexible elements (TPE compound). Injection moulding, injection moulding-insertion methods, extrusion, compression moulding methods may be mentioned by way of example. Injection moulding, injection moulding-insertion methods and extrusion are preferred, injection moulding-insertion methods are quite particularly preferred. A substantial advantage of the method described is that time-consuming and energy-intensive vulcanization steps can be dispensed with.

It is obvious that different bonds are produced using the present invention. The simplest is metal-TPE. Constructions of three and more layers (sandwich construction) can also be produced such as for example metal/TPE compound/metal.

Due to the in part very good adhesion to surfaces other than metallic surfaces, for example glass, ceramics and thermoplastics, bonds can be produced between more than two classes of material (metal, TPE). Those material bonds in which the TPE compound lies as an adhesive component between at least two materials are meant. A metal/TPE compound/thermoplastic bond may be mentioned by way of example.

The present invention also relates to the use of the TPE compounds according to the invention for producing various components and finished products, in which a metallic part or a part with a metallic surface coating, is to enter into a firm bond with an elastic element made of TPE, partially or completely. Typical fields of application are components, finished parts, shaped bodies, housings for electronic devices such as mobile phones, laptops, PCs, storage media. In addition, components, finished parts, shaped bodies, housings for interiors and exteriors of cars, industrial devices, industrial tools, household devices, sports equipment or other items such as watches or articles of jewellery.

A subject of the present invention is thus also the use of a TPE compound as described above for the production of a composite material with metals, glass, ceramic, thermoplastics and mixtures thereof.

Furthermore, it is preferable if the metal is selected from aluminium, copper, titanium, steel and stainless steel and/or alloys thereof.

The invention is now to be explained in more detail with reference to some embodiment examples, wherein these serve only as explanation and are not to be regarded as limiting the scope of protection of the invention.

### EMBODMENT EXAMPLES

1. Production of the TPE Compounds

All of the TPE compounds developed and tested according to the invention were produced on a twin screw extruder with co-rotating screws and a melting pump. The screw diameter is 27 mm, the L/D ratio is 46. The extruder has eight temperature-adjustable extruder zones. The rotational speed of the screw lies between 100 and 800 rpm. Granulation then takes place under water.

2. Raw materials Used

Polar-functionalized TPS (A):

KRATON FG 1901GT, KRATON MD 66845 GS

Adhesion-supporting resins (B):

ENDEX® 155, NORSOLENE® W140, EASTOTAC® H-130R

Process oils (C):

Shell Ondina® 941

Optionally MAH-grafted thermoplastic (PE):

SCONA TSPE 2102GAHDS

Further raw materials were used for the comparison examples.

Non-functionalized TPS:

Kraton G 1651 ES, SEPTON 4033

Thermoplastics (PP):

Moplen® HP 501 L

TPU:

DESMOPAN® 487

Filler:

OMYACARB® 5 GU

As described, all the examples were produced using twin screw extruders. The following Table 1 shows the corresponding proportions by weight of the components used.

TABLE 1
Composition of the compounds

| | | Reference | Reference | Reference | Exam- | Exam- | Exam- | Exam- |
|---|---|---|---|---|---|---|---|---|
| | | example I | example II | example III | ple IV | ple V | ple VI | ple VII |
| MAH-g-SEBS (HMW*) | wt. % | 0 | 0 | 0 | 0 | 60 | 0 | 0 |
| MAH-g-SEEPS (LMW*) | wt. % | 0 | 0 | 0 | 60 | 0 | 52 | 52 |
| aromatic resin | wt. % | 0 | 0 | 0 | 20 | 20 | 17 | 0 |
| aliphatic resin | wt. % | 0 | 0 | 0 | 0 | 0 | 0 | 17 |
| process oil | wt. % | 39.5 | 38 | 0 | 19.0 | 19.0 | 24.5 | 25 |
| TPS (SEBS, HMW*) | wt. % | 22 | 0 | 0 | 0 | 0 | 0 | 0 |
| TPS (SEEPS, LMW*) | wt. % | 0 | 45 | 0 | 0 | 0 | 0 | 0 |
| TPU | wt. % | 0 | 0 | 99.5 | 0 | 0 | 0 | 0 |
| PP | wt. % | 15 | 16 | 0 | 0 | 0 | 0 | 0 |
| MAH-g-PE | wt. % | 0 | 0 | 0 | 0 | 0 | 5.5 | 5.5 |
| filler | wt. % | 22 | 0 | 0 | 0 | 0 | 0 | 0 |
| pigment | wt. % | 0.5 | 0 | 0 | 0.5 | 0.5 | 0.5 | 0 |
| stabilizers | wt. % | 1.0 | 1.0 | 0.5 | 0.5 | 0.5 | 0.5 | 0.5 |

*LMW = low molecular weight; HMW = high molecular weight

3. Production of the Metal/TPE Compound Bond

Metal plates of aluminium which was pre-treated by means of the NMT method, were not further treated, but used directly.

Untreated metal plates of aluminium, steel and copper were successively pre-treated as follows:

a) Grinding of the surface to remove dirt and oxide layer using Scotch-Brite™ WR-RL abrasive web roll, red, Art. No. 61152.

b) Degreasing with acetone

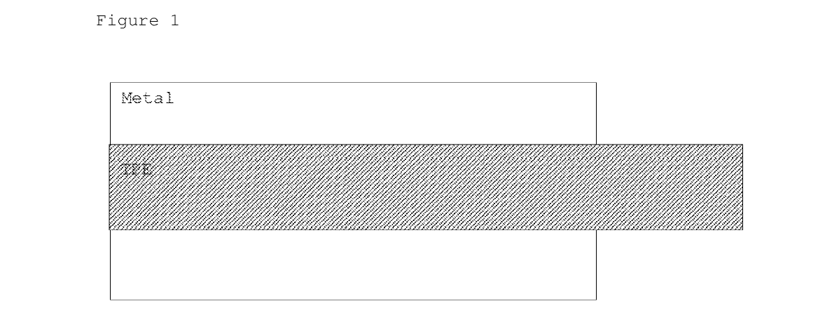

All the metal plates had the dimensions 115 mm×60 mm×1 mm. These plates were placed in the injection moulding tool using injection moulding-insertion methods and flooded with TPE melt. A centrally positioned TPE strip with a width of 20 mmm and a thickness of 1 mm was hereby produced as bond to the metal (see FIG. 1).

The thus-produced material bonds served as test pieces and were firstly subjected to the following tests for a minimum conditioning period of 24 hours under standard climate conditions. At least two samples of test pieces of the same bond were always produced.

4. Testing of the Adhesion

All the adhesion measurements were carried out on the test pieces produced following conditioning (see FIG. 1), on the basis of VDI 2019.

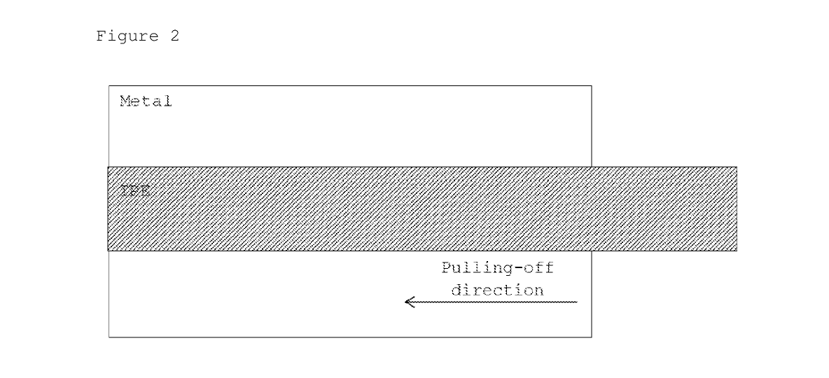

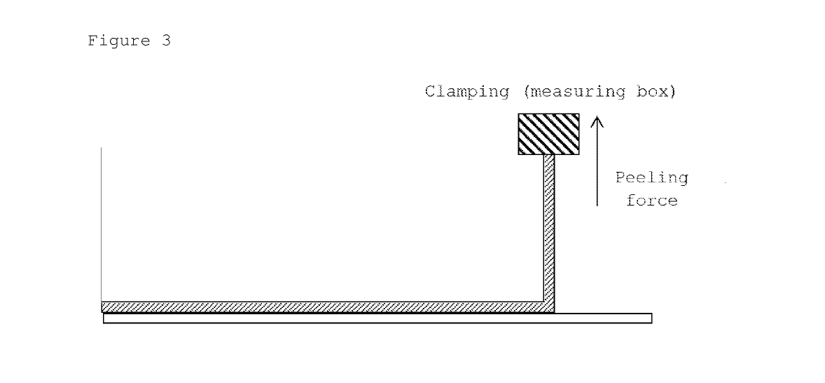

The pulling-off of the TPE strip took place at 90° to the metal plate test piece (see FIGS. 2 and 3 and VDI 2019). Adhesion measurements were additionally carried out on samples which have undergone chemical testing (see below under 6.).

5. Testing of the Further Parameters

For the testing of the further parameters, test plates of pure TPE compounds of Table 1 with the dimensions 125 mm×125 mm×2 mm were produced. Hardness, density, tensile strength and elongation at break were measured according to Table 2. The determination of hardness and density was carried out on these test plates or parts thereof. For the determination of tensile strength and elongation at break, S2 test pieces with a density of 2±0.05 mm which had been punched out of the “pure TPE” test plates were used in each case.

TABLE 2

| Method | Standard |
|---|---|
| Determination of hardness | ISO 7619-1 |
| Determination of density | DIN EN ISO 1183-1 |
| Determination of tensile | DIN 53504 |
| strength and elongation at | |
| break | |

6. Testing of Chemical Resistance

On the basis of DIN ISO 1817, respective test pieces (test pieces of FIG. 1 for adhesion testing, S2 test pieces for tensile strength and elongation at break, test plates or parts of the test plates named under 5. for hardness and density) were exposed to the following chemicals in succession:
85% phosphoric acid at 80° C. for 3 minutes
30% nitric acid at 23° C. for 3 minutes
70% sulphuric acid at 23° C. for 60 minutes
ammonium hydroxide pH 10 at 23° C. for 3 minutes

After each step the respective test pieces were thoroughly rinsed with distilled water. Following the action of all the chemicals, the samples were examined with respect to their parameters. If there were shown to be slight changes in the parameters in the case of hardness (±5 ShA), elongation at break (±20%), tensile strength (±30%) and swelling behaviour (±2%) the material was considered resistant. Resistance in the named test is hereafter to be equated with chemical resistance. Table 3 shows the starting values of the TPE compounds of Table 1. Table 4 shows the changes in the parameters after examination of the chemical resistance. In addition to the named parameter determinations, test pieces were assessed visually according to the grey scale (DIN EN 20105-A02/ISO 150-A02). Resistance is assumed if the test pieces are assessed not worse than grey scale level 4/5.

TABLE 3
Starting data of the TPE compounds before testing for chemical resistance

| | | Reference | Reference | Reference | Exam- | Exam- | Exam- | Exam- |
|---|---|---|---|---|---|---|---|---|
| | | example I | example II | example III | ple IV | ple V | ple VI | ple VII |
| density | g/cm³ | 1.025 | 0.89 | 1.196 | 0.94 | 0.942 | 0.93 | 0.918 |
| hardness | ShA | 60 | 60 | 86 | 75 | 73 | 71 | 50 |
| tensile strength | MPa | 4.8 | 8.7 | 41.8 | 14.8 | 10.3 | 8.7 | 7.1 |
| elongation at | % | 700 | 710 | 540 | 490 | 650 | 510 | 630 |
| break | | | | | | | | |
| adhesion to | N/mm | none | none | 4 | 4.8 | none | 4.4 | 2.3 |
| aluminium in the | | | | | | | | |
| NMT | | | | | | | | |
| adhesion to | N/mm | none | none | none | 3.7 | none | 3.5 | 1.7 |
| aluminium | | | | | | | | |
| adhesion to steel | N/mm | none | none | none | — | none | 4.6 | 2.7 |
| adhesion to | N/mm | none | none | none | — | none | 4.4 | — |
| copper | | | | | | | | |

TABLE 4
Data of the TPE compounds following the action of the chemicals

| | | Reference | Reference | Reference | Exam- | Exam- | Exam- | Exam- |
|---|---|---|---|---|---|---|---|---|
| | | example I | example II | example III | ple IV | ple V | ple VI | ple VII |
| volume | % | 0 | 0 | −3.6 | 0 | — | 0 | 0 |
| hardness | ShA | 0 | −2 | −8 | −1 | — | −1 | −3 |
| tensile strength | % | 10.9 | −24.8 | 13.9 | −25.4 | — | −26.4 | −15.3 |
| elongation at | % | 6.8 | −2.5 | 19.6 | 2.8 | — | 0.2 | 1.6 |
| break | | | | | | | | |
| grey scale | level | 5 | 5 | <1* | 5 | — | 5 | 5 |

*no longer assessable with grey scale, colour impression completely changed

7. Discussion

Examples I, II and III represent references. Although the compound of Example I is resistant to the above-named chemicals, it does not adhere to metals. Also, exchanging the non-functionalized TPS used for lower molecular weights does not change the behaviour. The reference compound III, a TPU, adheres well to aluminium pre-treated according to the NMT method, poorly to less pre-treated metals, but is not resistant to chemicals. Furthermore, pure TPUs are at the upper limit of the desired Shore A hardness. All the other examples IV to VII according to the invention achieve the objects of the present invention.

1. A thermoplastic composition comprising
(A) a polar-functionalized thermoplastic elastomer containing a styrene-containing block copolymer having a weight average molecular weight (M_{w}) of from 50,000 to 500,000 g/mol, wherein the polar-functionalized thermoplastic elastomer has polar groups selected from the group consisting of carboxylic acid, carboxylic acid anhydride, epoxy, hydroxy, amine, and amide groups,
(B) an adhesion-supporting resin, comprising aliphatic or aromatic synthetic resins or mixtures thereof, and
(C) a process oil.

2. The composition according to claim 1, wherein the thermoplastic elastomer has a Shore A hardness of from 30 to 90 ShA.

3. The composition according to claim 1, wherein the styrene-containing copolymer is an A-B-A triblock copolymer.

4. The composition according to claim 3, wherein the A block of the triblock copolymer is polystyrene and the B block of the triblock copolymer comprises polybutadiene, polyisoprene and/or polyisobutene.

5. The composition according to claim 4 wherein, in the A block the styrene monomers can be partially or completely replaced with derivatives of styrene, preferably α-methylstyrene, 2-methylstyrene, 3-methylstyrene, 4-methylstyrene, 4-tert-butylstyrene, 4-cyclohexylstyrene or vinylnaphthalines, preferably 1-vinylnaphthaline, or 2-vinylnaphthaline.

6. The composition according to claim 4, wherein the B block comprises a mixture of dienes.

7. The composition according to claim 4, wherein the B blocks are partially or completely hydrogenated.

8. The composition according to claim 1, wherein the thermoplastic elastomer has a grafting level of the polar groups of from 0.5 to 5.0%, relative to the polar-functionalized thermoplastic elastomer.

9. A composite material comprising a metal, glass, ceramic, thermoplastic, or any mixture thereof and the composition of claim 1.

10. The composite material according to claim 9, wherein the metal comprises aluminium, copper, titanium, steel, stainless steel, or any alloy thereof.

11. A method for the production of a thermoplastic elastomer composition according to claim 1 comprising using an extruder, internal mixer, or kneader.

12. A method for producing a composite material using a thermoplastic elastomer composition according to claim 1 and a further substance comprising a metal, glass, ceramic, thermoplastics and mixtures thereof, wherein the composite material is produced using injection moulding, injection moulding-insertion methods, extrusion, compression moulding methods, any combination thereof.

13. The method of claim 11, wherein the extruder is a twin screw extender.

14. The method of claim 13, wherein the composite material is produced using injection moulding, injection moulding-insertion methods, extension, or any combination thereof.

15. The method of claim 14, where the compsite materal is produced by injection moulding-insertion methods.
